(19) United States
(12) Patent Application Publication
(10) Pub. No.: US 2025/0337015 A1
(43) Pub. Date: Oct. 30, 2025

(54) ELECTROLYTE AND LITHIUM ION BATTERIES MADE THEREWITH

(71) Applicant: Wildcat Discovery Technologies, Inc., San Diego, CA (US)

(72) Inventors: Jinhua Huang, San Diego, CA (US); Peter Benington, San Diego, CA (US); Bin Li, San Diego, CA (US); Spencer Bravo, San Carlos, CA (US)

(21) Appl. No.: 19/184,058

(22) Filed: Apr. 21, 2025

Related U.S. Application Data
(60) Provisional application No. 63/639,137, filed on Apr. 26, 2024.

(51) Int. Cl. H01M 10/0567; H01M 4/38; H01M 4/525; H01M 10/0525; H01M 10/0569

(52) U.S. Cl. CPC H01M 10/0567; H01M 4/382; H01M 4/525; H01M 10/0525; H01M 10/0569; H01M 2300/0031; H01M 2300/0037

(57) ABSTRACT

Electrolytes comprising a solvating solvent, lithium salt and a halogenated alkane in an amount of 0.05% to 5% by weight of the electrolyte improve the cycling performance of lithium ion batteries and in particular lithium ion batteries having lithium metal anodes or anode-less anodes with Li intercalating cathode (e.g., cathodes comprised of layered nickel, manganese cobalt oxides).

The application is a non-provisional application of U.S. Ser. No. 63/639,137 filed Apr. 26, 2024, the specification of which is incorporated by reference herein in its entirety.

This invention is directed to lithium ion batteries and in particular an electrolyte useful for lithium ion batteries that are anode-less or having a lithium metal anode.

### BACKGROUND

Rechargeable lithium ion batteries that are anode-less (anode-less battery) or have a lithium metal anode (“lithium metal battery” or “LMB”), could dramatically increase the cell-level energy of state-of-the-art lithium ion batteries (LIBs) compared to those containing a carbon anode, due to the extremely low density, high theoretical capacity, and negative redox potential of Li metal. Unfortunately, the commercialization of LMBs is very challenging due to the high reactivity of Li metal anode, the formation of an unstable solid electrolyte interphase (SEI), the growth of Li dendrites, the evolution of inactive Li during the Li plating and stripping, and the volume change during the battery operation. These consequences eventually lead to a low coulombic efficiency (CE), shortened battery life, sluggish electrode kinetics and safety issues. Similar issues arise for so-called anode-less batteries (e.g., those using a metal current collector as the anode in which Li is deposited thereon during charging).

When cycling a battery, the stripping and plating of lithium on the anode may lead to formation of high surface area lithium and lithium dendrites. This may lead to capacity fade and catastrophic failure in batteries. To help stabilize batteries, high salt concentration electrolytes have been formulated and demonstrated to improve cycle performance for LMBs. In these types of high salt concentration electrolytes, it is believed essentially all of the solvent molecules are involved in solvating the salt cations minimizing, for example, the formation of solid electrolyte from decomposition/reaction of the solvent. This enables reduction of the salt anion for solid electrolyte (SEI) formation and may also increase the electrochemical stability of the electrolyte. The increased salt concentration also reduces ionic concentration gradients at the electrode, which may be responsible for inhomogeneous lithium deposition during cycling. A disadvantage to the superconcentrated electrolytes is the high viscosity of the formulation due to its high salt concentration, which may be detrimental, for example, to the power performance of the battery.

To attempt to remedy some of the shortcoming of high salt concentration electrolytes, a diluent solvent (diluent or diluting solvent) has been added to the high salt concentration electrolyte to form a localized high salt concentration electrolyte (LHCE) that has desirable viscosity while retaining some of the performance improvements of high concentration electrolytes (see, for example, U.S. Pat. Nos. 11,094,966 and 10,367,232). The diluent is soluble in the solvating solvent, but the salt is less soluble in the diluent than the solvating solvent.

Localized high concentration electrolytes (LHCE) contain a lithium salt (e.g., lithium bis (fluorosulfonyl) imide, LiFSI), solvating solvent (e.g., dimethoxy ethane, DME), as well as diluents such as 1,1,2,2-tetrafluoroethyl 2,2,3,3-tetrafluoropropyl ether (TTE). In LHCEs, diluent solvents do not disrupt the solvent structure of the primary solvent(s) around the ions from the salt, but largely reduces the viscosity of the electrolyte. Due to the highly solvated structure, the Li salt is able to be reduced and form a LiF rich solid electrolyte interphase (SEI), that has improved LMBs. However, further improvements are desirable, particularly for anode-less LIBs and lithium metal batteries (LMBs).

Accordingly, it would be desirable to provide electrolytes, and electrolyte-cathode combination to realize an anode-less LIB or LMB with improved performance such as longer cycle life and desirable power delivery.

### SUMMARY

An electrolyte that improves anode-less and a lithium metal batteries has been discovered that improves cycle life without adversely affecting desirable characteristics such as power delivery. For example, it has been discovered that particular halogenated alkanes when used in small amounts in an electrolyte comprised of a lithium salt and solvating solvent realizes improved cycle life compared to electrolytes in the absence of the halogenated alkanes. Small amounts of the halogenated alkane means that it is present in amount that is from about 0.05% to 2% by weight of the electrolyte. Anode-less or anode free battery herein is a battery that has an anode that is essentially free of: (i) lithium prior to the first charge and (ii) a lithium intercalating material such as graphite or titanium oxide. The anode-less battery may contain a metal or silicon that alloys with Li at battery operating conditions, but are not preferred. An LMB is a battery that contains a lithium metal anode, which, is a lithium metal foil/sheet or lithium metal layer deposited on a transition metal current collector such as copper or nickel that essentially do not alloy with Li (less than 1 or 2% by mole) at battery operating conditions. It is understood that the anode may contain certain carbons that are electroconductive, but substantially do not intercalate lithium (e.g., less than 1% by mole).

An first aspect is an electrolyte comprising a solution comprised of a solvating solvent, lithium salt and a halogenated alkane in an amount of 0.05% to 2% by weight of the electrolyte. Preferably, the electrolyte is a localized high concentration electrolyte (LHCE). An LHCE is a solution comprised of a solvating solvent, diluent and a dissolved lithium salt, the lithium salt generally being at least 5 times more soluble in the solvating solvent than the diluent.

Another aspect is a battery comprised of a separator, a cathode, an anode and the electrolyte of the first aspect. Desirably, the battery is comprised of an anode-less or lithium metal anode The anode-less anode is one that is absent a lithium intercalation material and may be, for example, a metal commonly used for anode current collectors (e.g., transition metals such as copper, nickel and alloys thereof and lithium metal in the case of an LMB) as well as electroconductive carbons that essentially do not intercalate lithium (less than 1 or 2% by mole of Li being intercalated). The anode may be comprised of other metals (e.g., Sn and Al) or Si that alloy with Li at battery operating conditions, but these are not preferred.

### BRIEF DESCRIPTION OF THE DRAWINGS

FIG. 1 displays the cycling behavior of batteries not of this invention.

FIG. 2 displays the cycling behavior of batteries of and not of this invention.

FIG. 3 displays the cycling behavior of batteries of this invention.

FIG. 4 displays the cycling behavior of batteries of and not of this invention.

FIG. 5 displays the cycling behavior of batteries of and not of this invention.

FIG. 6 displays the cycling behavior of batteries of and not of this invention.

### DETAILED DESCRIPTION

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

If not otherwise specified any characteristic or property may be determined by standard laboratory practices for determining such properties or characteristics The boiling temperature may be determined by ASTM D86 if not generally available in the literature. “Solubility” may be determined by the ‘shake flask’ method based on the guidelines provided by OECD, Paris, 1981, Test Guideline 107, Decision of the Council C(81) 30 final. “Viscosity” may be determined by ATSM D445 if not generally available in the literature.

The electrolyte comprises a solution comprised of a solvating solvent and a lithium salt and a halogenated alkane. The halogenated alkane is present in an amount of 0.05% to 5% by weight of the electrolyte with the amount desirably being from 0.1%, 0.2%, or 0.5% to 4%, 3%, or 2%. Solution is understood to be a liquid herein where each of the components of the solution are intermixed on a molecular level.

Halogenated alkane refers to a group containing one or more carbon atom backbones and hydrogen atoms, which contains one or more halogen heteroatoms. Generally, the halogenated alkane is comprised of 1 to 36 carbon and from 1 to 10, 8, 6, 5, 4, 3 or 2 heteroatoms. Preferably, the alkane has 1 to 12, 10, 8, 6, 4 or 3 carbons. When the halogenated alkane is linear (straight chain), it may be desirable for the linear halogenated alkane to have 1 to 2 halogens and the amount of carbons to be from 1 to 8, 6, 4, 3, or 2. When two halogens or more are present in a linear halogenated alkane they desirably are substituted on carbons separated by no more than one carbon (e.g., 1,2- and, 1,3-dichlorobutane as opposed to 1,4-dichlorobutane). “Halo” and “halogen” as used herein refer to an atom selected from fluorine (fluoro, —F), chlorine (chloro, —Cl), bromine (bromo, —Br), and iodine (iodo, —I). The halogenated alkane may cyclic (including fused, bridging, and spiro-fused polycyclic), linear, branched or combination thereof. The halogenated alkane may be substituted with either chlorine, fluorine or combination thereof. Or the halogenated alkane may be substituted with either chlorine or fluorine, but not both. That is, the halogenated alkane is substituted with only 1 or more fluorines or one or more chlorines without any other halogens being substituted.

If not otherwise specified any characteristic or property may be determined by standard laboratory practices for determining such properties or characteristics The boiling temperature may be determined by ASTM D86 if not generally available in the literature. “Solubility” may be determined by the ‘shake flask’ method based on the guidelines provided by OECD, Paris, 1981, Test Guideline 107, Decision of the Council C(81) 30 final. “Viscosity” may be determined by ATSM D445 if not generally available in the literature.

The battery is comprised of an electrolyte. Any electrolyte suitable for use in lithium ion batteries may be used, but generally it is desirable for the electrolyte to be a high salt concentration electrolyte such as those known in the art. The electrolyte is a solution comprised of a lithium salt and a solvent. Desirably, the electrolyte also comprises a diluent that is soluble in the solvating solvent, but does not solubilize the salt to form a localized high concentration electrolyte (LHCE). Illustratively, the LHCE generally has solvating solvent, diluent and a dissolved lithium salt, the lithium salt typically being at least 2, 3 or 5 times more soluble in the solvating solvent than the diluent.

The LHCE may include a combination of diluents with different substitutions. For examples, a combination of diluents containing linear alkyl groups, branched alkyl groups, or both may provide for a different miscible molar ratio with the solvating solvent while achieving desirable discharge capacity and capacity retention.

The LHCE may include any number of different diluents sufficient to be miscible with the solvating solvent and/or adjust the viscosity of the electrolyte. For example, the electrolyte may include one or more, two or more, three or more, four or more, or a plurality of diluents.

The diluent may include one or more fluorinated ethers. The fluorinated ethers may be any compound that includes a combination of ether groups, fluorine atoms, and carbon atoms that are fully saturated with hydrogen.

Examples of fluorinated ethers may include one or more of 1,1,2,2-tetrafluoroethyl 2,2,3,3-tetrafluoropropyl ether (TTE); bis (2,2,2-trifluoroethyl) ether (BTFE), hexafluoroisopropyl methyl ether (HFPME); 1,1,2,2-tetrafluoroethyl ethyl ether (TFEEE); 1H,1H,5H-octafluoropentyl 1,1,2,2,-tetrafluoroethyl ether (OFPTFEE); 1,1,2,2-tetrafluoroethyl ether, 1,2-(1,1,2,2,-tetrafluoroethoxy) ethane (TFEE); 1,3-(1,1,2,2-Tetrafluoroethoxy) propane (TFEP), 1,1,2,3,3,3-hexafluoro propyl 2,2,2-trifluoroethyl ether (HFPTFEE); n-butyl 1,1,2,2-tetrafluoroethyl ether (BTFEE); 1H,1H,2′H,3H-decafluoro dipropyl ether (DFDPE); 1,1,2,3,3,3-hexafluoropropyl ethyl ether (HFPEE); 1,1,1-trifluoro-2-[1-(2,2,2-trifluoroethoxy)ethoxy] ethane (TTFEEE); 1H, 1H,2′H-perfluorodipropyl ether (PFDPE); 1,1,2,2-tetrafluoroethyl isobutyl ether (TFEBE); 1,1,1,2,2,3,4,5,5,5-decafluro-2-methoxy-4-(trifluoromethyl) pentane; 1-(ethoxy) nonafluorobutane having a mixture of n- and iso-butyl isomers; 2-(trifluoromethyl)-3-ethoxydodecafluorohexane; 3-methoxyperfluoro (2-methylpentane); heptafluoropropyl 1,2,2,2-tetrafluoroethyl ether; 1,1,2,2-tetrafluoroethyl-2,2,2-trifluoroethyl ether (TFTFE); methoxynonafluorobutane (MOFB); ethoxynonafluorobutane (EOFB); tris (2,2,2-trifluroethyl) orthoformate; di (2,2,2-trifluroethyl) carbonate; or any combination thereof.

The solvating solvent may be any solvent or combination of solvents that are miscible in the diluent and/or can dissolve the lithium salt with or without the presence of the diluent. The electrolyte may include any number of solvating solvents sufficient to form desirable solvation around cation and/or anion of the lithium salt. For example, the electrolyte may include one or more, two or more, three or more, four or more, or a plurality of solvating salts. The solubility of the salts in the solvating solvent and/or diluent may be essentially the same and or different. It may be desirable, for example, to have one salt that has a greater solubility (e.g., 5%, 10% or 20% more soluble than the other salts) in the diluent, which may be desirable in forming an advantageous SEI layer. In some examples, the solvating solvent may include one or more of dialkoxy alkanes, dialkyl glycol ethers, disubstituted esters, disubstituted carbonates, trisubstituted phosphates, disubstituted sulfones, tetrasubstituted silanes, or any combination thereof.

Dialkoxy alkanes may include a pair of alkyl ethers bound by a C₁₋₁₂ alkane group that may be branched or linear. For example, dialkoxy alkanes may include one or more of dimethoxy ethane (DME), 1,2-Diethoxyethane (DEE), 1,2-dimethoxypropane (DMP), The dialkoxy alkane may have the following structure:

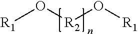

where each R₁ may independently comprise a C₁₋₁₂ alkyl group that may be linear or branched, or any combination thereof.
where R₂ may comprise a C₁₋₁₂ alkyl group that may be linear or branched, or any combination thereof.
where n is an integer between 1 and 5.

Dialkyl glycol ethers may include a series of three either groups separated by alkyl chains that may be linear or branched. Example of dialkyl glycol eithers may include one or more of 1,2-diethylene glycol isopropyl methyl ether (DEGIM), diethylene glycol butyl methyl ether (DEGBM), or any combination thereof. The dialkyl glycol may have the following structure:

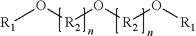

where each R₁ may independently comprise a C₁₋₁₂ alkyl group that may be linear or branched, or any combination thereof.
where each R₂ may independently comprise a C₁₋₁₂ alkyl group that may be linear or branched, or any combination thereof.
where each n is an integer between 1 and 5.

Disubstituted esters may include an ester that is substituted at the carbon atom of the carbonyl or the oxygen atom of the hydroxyl group by one or more groups including hydrogen, C₁₋₁₂ alkyl, C₁₋₁₂ aryl, or any combination thereof. Examples of disubstituted esters may include one or more of ethyl difluoroacetate, ethyl propionate, or any combination thereof. The disubstituted ester may have the following structure:

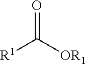

where each R₁ may independently comprise a hydrogen atom, a C₁₋₁₂ alkyl group that may be linear or branched, a hetero-alkyl group that may be linear or branched, or any combination thereof. Both R₁ in combination may form a cyclic alkyl ring that may optionally include one or more hetero atoms.

Disubstituted carbonates may be substituted independently at each of the carbon atoms. Disubstituted carbonates may include dimethyl carbonate, diethyl carbonate, ethyl methyl carbonate, fluoroethylene carbonate, or any combination thereof. The disubstituted carbonate may have the following structure:

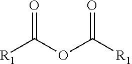

where each R₁ may independently comprise a hydrogen atom, a C₁₋₁₂ alkyl group that may be linear or branched, a hetero-alkyl group that may be linear or branched, or any combination thereof. Both R₁ in combination may form a cyclic alkyl ring that may optionally include one or more hetero atoms.

Trisubstituted phosphates may be substituted at each of the single bonded oxygen atoms. Trisubstituted phosphates may include trimethyl phosphate, triethyl phosphate, or any combination thereof. The trisubstituted phosphates may have the following structure:

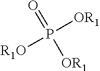

where each R₁ may independently comprise a hydrogen atom, a C₁₋₁₂ alkyl group that may be linear or branched, a hetero atom, a hetero-alkyl group, or any combination thereof.
where each R₂ may independently comprise a hydrogen atom, C₁₋₁₂ alkyl group that may be linear or branched, or any combination thereof.

Disubstituted sulfones may be substituted at the sulfur atom by one or more groups including hydrogen, C₁₋₁₂ alkyl, C₁₋₁₂ aryl, or any combination thereof. Disubstituted sulfones may include sulfolane, methyl ethyl sulfone, methyl isopropyl sulfone, or any combination thereof. The disubstituted sulfones may have the following structure:

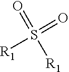

where each R₁ may independently comprise a hydrogen atom, a C₁₋₁₂ alkyl group that may be linear or branched, a hetero-alkyl group that may be linear or branched, or any combination thereof. Both R₁ in combination may form a cyclic alkyl ring that may optionally include one or more hetero atoms.

Tetrasubstituted silanes may be substituted at the silicon atom and/or each oxygen atom. Tetrasubstituted silanes may include triethyoxymethyl silane, trimethoxymethylsilane, or any combination thereof. The tetrasubstituted silanes may have the following structure:

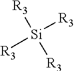

where each R₃ may independently comprise a hydrogen atom, a C₁₋₁₂ alkyl group that may be linear or branched, a hetero atom, a hetero-alkyl group, C₁₋₁₂ alkoxy group that may be linear or branched, a hetero atom, a hetero-alkyl group, or any combination thereof. Further illustrations of suitable solvents and diluents are described in U.S. Pat. No. 10,367,232 and copending U.S. Provisional Application 63/435,662 incorporated herein by reference.

The lithium salt may be any suitable lithium salt such as those known in the art. Typically, the lithium salt may have a solubility in the solvating solvent of about 1 M or more, about 3 M or more, or about 5 M or more. The lithium salt may have a solubility in the solvating solvent of about 20 M or less, about 15 M or less, or about 10 M or less. The lithium salt may be present in a concentration of about 3.5 M or less, about 2.0 M or less, or about 1.5 M or less. The lithium salt and combination of diluent/solvating solvent may be present in a molar ratio of about 1:2 or more, 1:2.6 or more, or 1:3.2 or more. The lithium salt and combination of diluent/solvating solvent may be present in a molar ratio of about 1:6 or less, about 1:5 or less, or about 1:4.

The lithium salt may include one or more of (oxalato)borate (LiBOB), lithium bis(pentafluoroethylsulfonyl)imide (Li-BETI), lithium bis(fluorosulfonyl)imide (LiFSI), lithium lithium tetrafluoroborate (LiBF₄), trifluoromethanesulfonate (LiTriflate), lithium hexafluoroarsenate (LiAsF₆), lithium bis (trifluoromethanesulfonimide) (LiTFSI), and lithium hexafluoro-phosphate (LiPF₆), lithium nitrate (LiNO₃), LiN(SO₂CF₃)₂, LiN(SO₂F)₂, LiCF₃SO₃, LiClO₄, lithium difluoro oxalato borate anion (LiDFOB), LiI, LiBr, LiCl, LiOH, LiSO₄, or any combination thereof.

In some examples, another salt may be included in the electrolyte, such as another alkali metal salt, an alkaline earth metal salt, or any combination thereof. For example, the lithium salt may include a sodium salt, a magnesium salt, a mixture of lithium and sodium salts, a mixture of lithium and magnesium salts, a mixture of lithium, magnesium, and sodium salts, a mixture of sodium and magnesium salts, or any combination thereof. For example, the lithium salt may include one or more of sodium bis(fluorosulfonyl)imide (NaFSI), sodium bis(trifluoromethylsulfonyl)imide (NaTFSI), sodium bis(oxalato)borate (NaBOB), NaFSI, NaTFSI, any lithium salt, or any combination thereof.

Other exemplary LHCE combinations may include salt comprising lithium bis(fluorosulfonyl)imide (LiFSI), lithium bis(trifluoromethylsulfonyl)imide (LiTFSI), sodium bis(fluorosulfonyl)imide (NaFSI), sodium bis(trifluoromethylsulfonyl)imide (NaTFSI), lithium bis(oxalato)borate (LiBOB), LiPF₆, LiAsF₆, LIN(SO₂CF₃)₂, LiN(SO₂F)₂, LiCF₂SO₃, LiC10₄, lithium difluoro oxalato borate anion (LiDFOB), LiI, LiBr, LiCl, LiOH, LiNO₃, LiSO₄, or any combination thereof, a solvating solvent comprising dimethoxyethane (DME), 1,2-diethoxyethane (DEE), dimethylcarbonate (DMC), 1,3-dioxolane (DOL), ethyl methyl carbonate (EMC), diethyl carbonate (DEC), dimethyl sulfoxide (DMSO), ethyl vinyl sulfone (EVS), tetram-ethylene sulfone (TMS), ethyl methyl sulfone (EMS), ethylene carbonate (EC), vinylene carbonate (VC), fluoroethylene carbonate (FEC), 4-vinyl-1,3-dioxolan-2-one, dimethyl sulfone, methyl butyrate, ethyl propionate, trimethyl phosphate, triethyl phosphate, gamma-butyrolactone, 4-methylene-1,3-dioxolan-2-one, methylene ethylene carbonate (MEC), 4,5-dimethylene-1,3-dioxolan-2-one, allyl ether, triallyl amine, triallyl cyanurate, triallyl isocyanurate or any combination thereof (the salt being present at a molar ratio of salt/solvating solvent of about 0.7 to 1.5) and a diluent comprising 1,1,2,2-tetrafluoroethyl-2,2,2,3-tetrafluoropropyl ether (TTE), bis(2,2,2-trifluoroethyl) ether (BTFE), 1,1,2,2-tetrafluoroethyl ether, 1,2-(1,1,2,2,-tetrafluoroethoxy) ethane (TFEE); 1,3-(1,1,2,2-Tetrafluoroethoxy) propane (TFEP), 1,1,2,2,-tetrafluoroethyl-2,2,2-trifluoroethyl ether (TFTFE), methoxynonafluorobutane (MOFB), ethoxynonafluorobutane (EOFB), or any combination thereof.

Particular useful LHCEs are comprised of the following combinations: a lithium bis(fluorosulfonyl)imide (LiFSI), dimethoxyethane (DME), 1,1,2,2-tetrafluoroethyl 2,2,3,3-tetrafluoropropyl ether (TTE) combination; LiFSI, DME, 1,2-(1,1,2,2-Tetrafluoroethoxy) ethane (TFEE) combination; LiFSI, DME, 1H,1H,5H-octafluoropentyl 1,1,2,2,-tetrafluoroethyl ether (OFPTFEE) combination; LiFSI, DME, 1,3-(1,1,2,2-Tetrafluoroethoxy) propane (TFEP) combination; LiFSI, DEE, TTE combination; LiFSI, DEE, TFEE combination; LiFSI, DEE, OFPTFEE combination; or LiFSI, DEE, TFEP combination. The molar ratios of these may be (salt: solvating solvent: diluent) 1±0.2:1.2±0.3: 3±2.

The electrolyte is particularly useful for a battery comprised of anode absent a lithium intercalation material. That is the battery is an anode-less battery or LMB as described above. That is the anode in an anode-less battery is essentially a metal or electrically conductive material that does not intercalate lithium ions and preferably essentially does not alloy with Li at battery operating conditions. Exemplary materials include those suitable as current collectors such as a transition metal or alloy with copper, nickel and alloys of each being illustrative. In some embodiments, the anode may be comprised of an electrically conductive carbon. Electrically conductive carbons are as defined above and an illustration of such a carbon may be carbon black such as those available from Timcal under the tradename SUPER P. Preferably, the anode is a transition metal current collector. It is recognized upon the initial charging of the battery (oxidation of the cathode), lithium ions from the oxidation of the cathode coats the anode (e.g., transition metal/electrically conductive carbon current collector/sheet with lithium). When an electrically conductive carbon is present, typically it is present as a coating on the transition metal current anode sheet or foil including a binder such as described herein and as described in U.S. Pat. No. 9,172,085 incorporated herein by reference.

The battery may be a so-called lithium metal battery (LMB), wherein the anode is comprised of lithium metal or lithium metal alloy prior to the initial charging of the battery. The lithium metal may be present in any suitable amount and typically is present as a thin layer upon a transition metal current collector such as described above for the anode-less battery (1 or 5 micrometers to 50, 30 or 20 micrometers thick layer). The LMB likewise is free of an intercalation material but may be comprised of other components as described for the anode-less battery.

The battery is comprised of a cathode. Generally, the cathode is comprised of a current collector, which may be a sheet or foil of a transition metal as described for the anode coated with a cathode material (one capable of intercalating Li). Typically, the cathode material (powder) is coated on the current collector using a binder and electrically conductive materials. The binder may be any suitable such as those known in the art and may include, for example, carboxy methyl cellulose (CMC), styrene-butadiene rubber (SBR), polyvinylidene fluoride (PVDF), poly-tetrafluoroethylene (PTFE), or a mixture of two or more thereof. Desirably, the cathode is comprised of PVDF. The electrically conducting additive may be any suitable such as graphite, carbon black, carbon nanotubes, graphene and carbon fiber. The amount of other cathode components may be any suitable amount, but generally is at most about 20% or 10% by weight to about 0.1%, 0.5% or 1% by weight of the cathode (i.e., cathode material and other cathode components not including the current collector).

The cathode material may be any suitable for intercalating Li such as those known in the art. Illustratively, the cathode material may be a lithium transition metal oxide, a transition metal sulfide, and the like. The cathode may include any material sufficient to have desirable discharge capacity and charge retention when used with an anode. Examples of suitable cathode materials may include phosphates, fluorophosphates, fluorosulfates, fluorosilicates, spinels, lithium-rich layered oxides, and composite layered oxides. Further examples of suitable cathode materials may include spinel structure lithium metal oxides, layered structure lithium metal oxides, lithium-rich layered structured lithium metal oxides, lithium metal silicates, lithium metal phosphates, metal fluorides, metal oxides, sulfur, metal sulfides, disordered rock salt structures, or any combination thereof.

Illustratively, the positive electrode material may be at least one complex oxide of lithium and a metal selected from cobalt (Co), nickel (Ni), and a combination thereof, and 65 more particularly, a compound represented by at least one Formula of LiₐA_{1-b}B_{b}D₂ (wherein, 0.90≤1.8 and 0≤b≤0.5); LiaE_{1-b}B_{b}O_{2-c}D_{c} (wherein, 0.90≤a≤1.8, 0≤b≤0.5, 0≤c≤0.05); LiE_{2-b}B_{b}O_{4-c}D_{c} (wherein, 0≤b≤0.5, 0≤c≤0.05); LiₐNi_{1-b-c}CO_{b}B_{c}D_{α} (wherein, 0.90≤a≤1.8, 0≤b≤0.5, 0≤c≤0.05, 0<α≤2); LiₐNi_{1-b-c}Co_{b}B_{c}O₂₋ₐF_{α} (wherein, 0.90≤a≤1.8, 0≤b≤0.5, 0≤c≤0.05, 0<α≤2); LiₐNi_{1-b-c}CO_{b}B_{c}O₂₋ₐF_{α} (wherein, 0.90≤a≤1.8, 0≤b≤0.5, 0≤c≤0.05, 0<α≤2); LiₐNi_{1-b-c}Mn_{b}B_{c}Dα (wherein, 0.90≤a≤1.8, 0≤b>0.5, 0≤c≤0.05, 0<α≤2); LiₐNi_{1-b-c}Mn_{b}B_{c}O_{2-α}F_{α} (wherein, 0.90≤a≤1.8, 0≤b≤0.5, 0≤c≤0.05, 0<α<2); LiₐNi_{b}E_{c}G_{d}O₂ (wherein, 0.90≤a≤1.8, 0≤b≤0.9, 0≤c≤0.5, 0.001≤d≤0.1); LiₐNi_{b}Co_{c}Mn_{d}GeO₂ (wherein, 0.90≤a≤1.8, 0≤b≤0.9, 0≤c≤0.5, 0≤d≤0.5); LiₐNiG_{b}O₂ (wherein, 0.90≤a≤1.8, 0.001≤b≤0.1.); LiₐCoG_{b}O₂ (wherein, 0.90≤a≤1.8, 0.001≤b≤0.1); LiₐMnG_{b}O₂ (wherein, 0.90≤a≤1.8, 0.001≤b≤0.1); LiₐMn₂G_{b}O₄ (wherein, 0.90≤a≤1.8, 0.001≤b≤0.1); QO₂; QS₂; LiQS₂; V₂O₅; LiV₂O₂; LiIO₂; LiNiVO₄; Li_{(3-f)}J₂PO₄)₃ (wherein 0≤f≤2); Li_{(3-f)}Fe₂(PO₄)₃ (wherein 0≤f≤2); and LiFePO₄.

In the formulae above, A is Ni, Co, manganese (Mn), or a combination thereof; B is aluminum (Al), Ni, Co, Mn, chromium (Cr), iron (Fe), strontium (Sr), vanadium (V), or a combination thereof; D is oxygen (O), fluorine (F), sulfur(S), phosphorus (P), or a combination thereof; E is Co, Mn, or a combination thereof; F is F, S, P, or a combination thereof; G is Al, Cr, Mn, Fe, magnesium (Mg), lanthanum (La), Cerium (Ce), Sr, V, or a combination thereof; Q is titanium (Ti), molybdenum (Mo), Mn, or a combination thereof; I is Cr, V, Fe, scandium (Sc), yttrium (Y), or a combination thereof; J is V, Cr, Mn, Co, Ni, copper (Cu), or a combination thereof.

Desirably, the cathode is a lithium metal phosphate or lithium oxide comprised of Ni, Mn, and Co (NMC). The NMC desirably is one have at least 50%, 60%, 70% or 75% by mole Ni of the total moles of the Ni, Mn and Co present in the NMC. Preferably, the NMC is a layered oxide.

The battery is comprised of separator, which may any suitable separator such as those known in the art. Illustratively, the separator may have one or more layers that may be bonded together. Examples of suitable separators includes a poly-imide, polyolefin (such as polypropylene), polyethylene terephthalate, ceramic-coated polyolefin, cellulose, or a mixture of two or more thereof. Such materials may be in the form of microfibers or nanofibers. The separator may include a combination of microfibers and nanofibers. In certain embodiments, the separator includes polyethylene terephthalate microfibers and cellulose nanofibers.

A separator having multiple layers may be used, each of which may have differing melting points. However, one of these layers may have a melting point lower than the other layer and may serve the purpose of a shutdown separator. For example, an inner layer of a separator may have a melting point of approximately 130° C. and a layer that may have a melting point of approximately 160° C. In this illustration, the inner layer would melt at a temperature of about 130° C., preventing ion flow in the battery but maintaining physical separation between the anode and cathode to prevent shorting. An example of a useful material having a melting point of approximately 130° C. is high density polyethylene or ultra high molecular weight polyethylene. Examples of useful materials that have a melting point of >200° C. include polyimide, polyethylene terephthalate, cellulose, aramid fibers, ceramics, and combinations thereof. In certain embodiments, the multiple separator layers with different melting points may be laminated together to form a single multi-layer composite separator. In certain embodiments, a layer of positive temperature coefficient material may be used.

### ILLUSTRATIONS

Illustration 1. An electrolyte comprising a solution comprised of a solvating solvent, lithium salt and a halogenated alkane in an amount of 0.05% to 5% by weight of the electrolyte.

Illustration 2. The electrolyte of illustration 1, wherein the amount is 0.1% to 2%.

Illustration 3. The electrolyte of either illustration 1 or 2, wherein the halogenated alkane has from 1 to 12 carbons.

Illustration 4. The electrolyte of any one of the preceding illustrations, wherein the halogenated alkane is substituted with at most 5 halogens.

Illustration 5. The electrolyte of illustration 4, wherein the halogenated alkane is substituted with at most 3 halogens.

Illustration 6. The electrolyte of any one of the preceding illustrations wherein the halogenated alkane is cyclic.

Illustration 7. The electrolyte of any one of illustrations 1 to 5, wherein the halogenated alkane is linear.

Illustration 8. The electrolyte of illustration 6 or 7, wherein the halogenated alkane is monosubstituted.

Illustration 9. The electrolyte of either illustration 7 or 8, wherein the halogenated alkane has from 1 to 10 carbons.

Illustration 10. The electrolyte of illustration 6 or 7, wherein the halogenated alkane is at least di-substituted with a halogen.

Illustration 11. The electrolyte of illustration 10, wherein the halogens present in the halogenated alkane are not separated by more than 1 carbon.

Illustration 12. The electrolyte of illustration 11, wherein the halogenated alkane has from 1 to 10 carbons.

Illustration 13. The electrolyte of any one of the preceding illustrations, wherein the halogenated alkane is substituted with chlorine, fluorine or combination thereof.

Illustration 14. The electrolyte of any one of illustrations 1 to 13, wherein the halogenated alkane is substituted with either chlorine or fluorine, but not both.

Illustration 15. The electrolyte of any one of the preceding illustrations, wherein the electrolyte is a localized high salt concentration electrolyte (LHCE) further comprised of a diluent.

Illustration 16. The electrolyte of illustration 15, wherein the LHCE is comprised of a lithium bis(fluorosulfonyl)imide (LiFSI), dimethoxyethane (DME), 1,1,2,2-tetrafluoroethyl 2,2,3,3-tetrafluoropropyl ether (TTE) combination; LiFSI, DME, 1,2-(1,1,2,2-Tetrafluoroethoxy) ethane (TFEE) combination; LiFSI, DME, 1H,1H,5H-octafluoropentyl 1,1,2,2,-tetrafluoroethyl ether (OFPTFEE) combination; LiFSI, DME, 1,3-(1,1,2,2-Tetrafluoroethoxy) propane (TFEP) combination; LiFSI, DEE, TTE combination; LiFSI, DEE, TFEE combination; LiFSI, DEE, OFPTFEE combination; or LiFSI, DEE, TFEP combination.

Illustration 17. A battery comprised of the electrolyte of any one of the preceding illustrations, a cathode, anode and separator.

Illustration 18. The battery of illustration 17, wherein the anode is comprised of a lithium metal anode.

Illustration 19. The battery of illustration 17 or 18, wherein the cathode is a layered oxide.

Illustration 20. The battery of illustration 19, wherein the layered oxide is comprised of Ni, Mn, Co.

Illustration 21. The battery of illustration 20, wherein the Ni is at least 50% by mole of the Ni, Mn and Co in the layered oxide.

Illustration 22. The battery of illustration 17, wherein the anode is comprised of an anode-less anode.

### EXAMPLES

The following examples are intended to be illustrative and do not unduly limit the scope of the disclosure.

Battery cells are made with the same materials other than different electrolytes including different halogenated alkanes. Battery cells are formed in a high purity Argon filled glove box (M-Braun, O₂ and humidity content <0.1 ppm). In the case of the cathode, a commercial high Ni NMC (Ni content ≥80%, referred to herein as NMC811)) active material is mixed with polyvinylidene fluoride (PVDF), carbon black powder, and liquid 1-methyl-2-pyrolidinone (NMP) to form a slurry. The resulting slurry is deposited on an aluminum current collector and dried to form a composite cathode film. The anode is a commercially available 20 mm thick lithium foil coated on a copper current collector. Each battery cell includes a composite cathode film deposited on a current collector, a polypropylene separator, and the lithium metal anode.

A localized high salt concentration electrolyte is prepared by molar ratio. For example, the electrolyte referred to as “control” is prepared by mixing lithium bis (fluorosulfonyl) imide (LiFSI), dimethoxyethane (DME), and 1,1,2,2-tetrafluoroethyl 2,2,3,3-tetrafluoropropyl ether (TTE) in a 1/1.2/3 molar ratio, which unless otherwise stated is the electrolyte that is used in the Examples (with the halogenated alkane at the prerequisite level) and Comparative Example (Control without the presence of a halogenated alkane). The halogenated alkane is added by weight of the electrolyte (0.2%, 0.5%, and 2%). The amount of electrolyte used is a lean amount to accentuate the effect of the halogenated alkane on the performance of the battery. A lean electrolyte amount is an amount of electrolyte that is about 20% greater than the amount of open porosity in the cathode and anode (noting there is no open porosity in the Examples battery cells). The amount of electrolyte in the battery may be any useful such as from lean to 20× or 10× the volume of open porosity in the cathode and anode of the battery. The battery cell was then sealed and initially cycled at ambient temperature using 0.1C charge to upper cutoff voltage 4.3V followed by constant voltage hold until the current dropped to 0.05C and then discharged to 2.7V using 0.1C constant current. The cycle was repeated one more time prior to being cycled at 0.33C/0.33 for subsequent cycles. All cycling was performed at about 25° C.

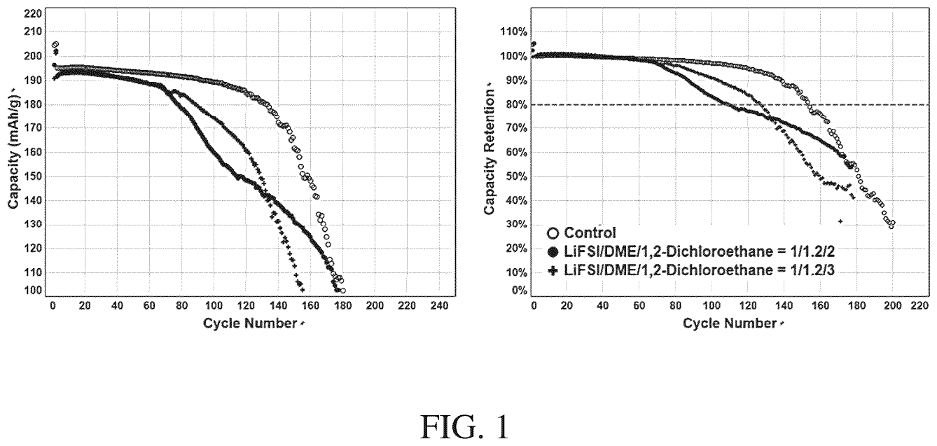

An electrolyte where dichloroethane is a co-solvent with DME is made by mixing by moles 1:1.2:2 and 1:1.2:3 of LiFSI: DME: 1,2-Dichloroethane (Comparative Examples 2 and 3) and the cycling behavior of LMBs are shown in FIG. 1. These electrolytes had a % by weight of the halogenated alkane in the electrolyte of ˜33% by weight for Comparative Example 2 and ˜43% by weight for Comparative Example 3. Compared with the control, the LMB's cycling behavior is degraded as shown in FIG. 1.

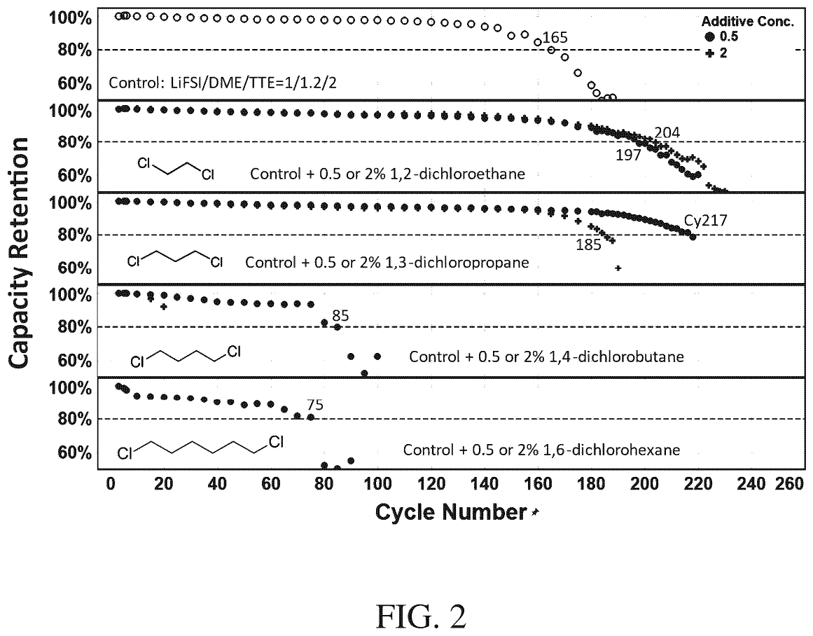

Further examples of dichlorinated alkanes are shown in Table 1 with the cycling of LMBs with electrolytes having these additives shown in FIG. 2. LMBs with 1,2-dichlorethane exhibited better cycling performance relative to the control when used as an additive. The cycle life of the electrolyte improved from 165 cycles to 204 cycles (80% capacity retention) when 2% of the 1,2-dichloroethane was used. This result differs from those with 1,2-dichloroethane when used a co-solvent as shown for Comparative Examples 2 and 3. That is, large amounts of 1,2-dichloroethane did not display greater cycle life. When the 1,2-dichloroethance concentration is reduced to 0.5%, the cycle life was slightly reduced to 197 cycles. When the carbon chain of dichlorinated alkane is increased. Both 1,4-dichlorobutane and 1,6-dichlorohexane showed worse cycling performance. Especially with 2% of these two additives, the battery barely could be cycled. However, 0.5% of 1,3-dichloropropane delivered the best cycle life among LMBs having these dichlorinated linear alkanes as additives in the electrolyte (217 cycles).

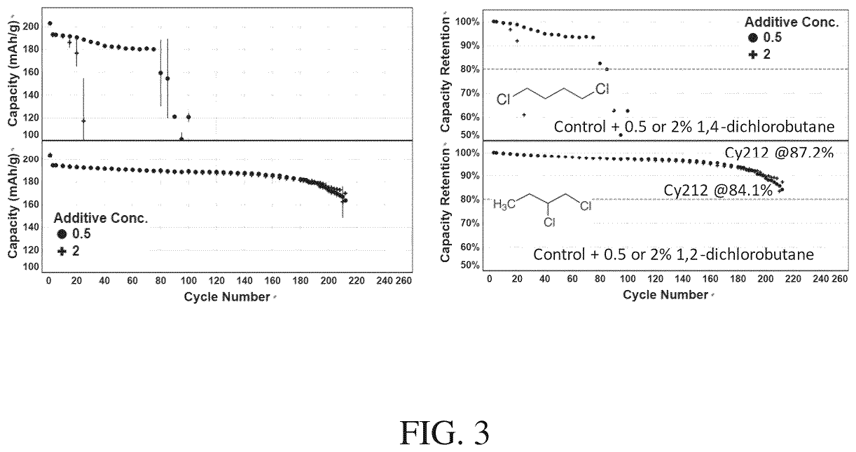

FIG. 3 shows the cycling performance LMBs where the electrolyte additive is 1,2-diclorobutane compared to 1,4-dichlorobutane. That is, we have discovered that linear halogenated alkanes having halogen substitution that is not separated by more than 1 carbon, substituted on adjacent carbons or on the same carbon realizes improved cycling performance compared to when the halogen separation is greater than one carbon as demonstrated by the cycling of 1,2-diclorobutane compared to 1,4-dichlorobutane and the cycling performance of 1,3-dichloropropane.

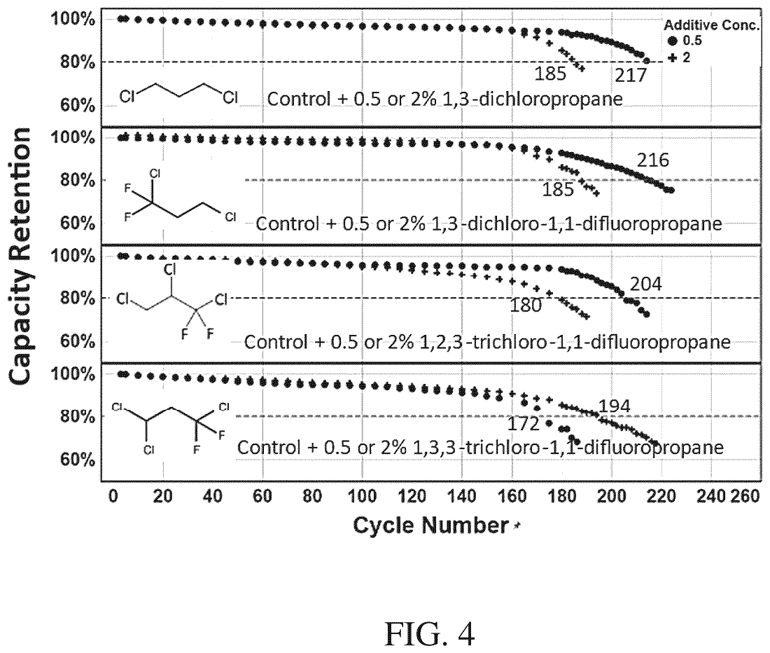

FIG. 4 shows the cycling performance LMBs using electrolytes where the additive has further halogenation of 1,3-chloropropane with fluorine and chlorine. From the cycling behavior, the further halogenation essentially realizes the same performance as 1,3-dichloropropane (1,3-dichloro-1,1-difluoropropane, 1,2,3-trichloro-1,1-difluoropropane and 1,3,3-trichloro-1,1-difluoropropane) when used as an additive in the electrolyte.

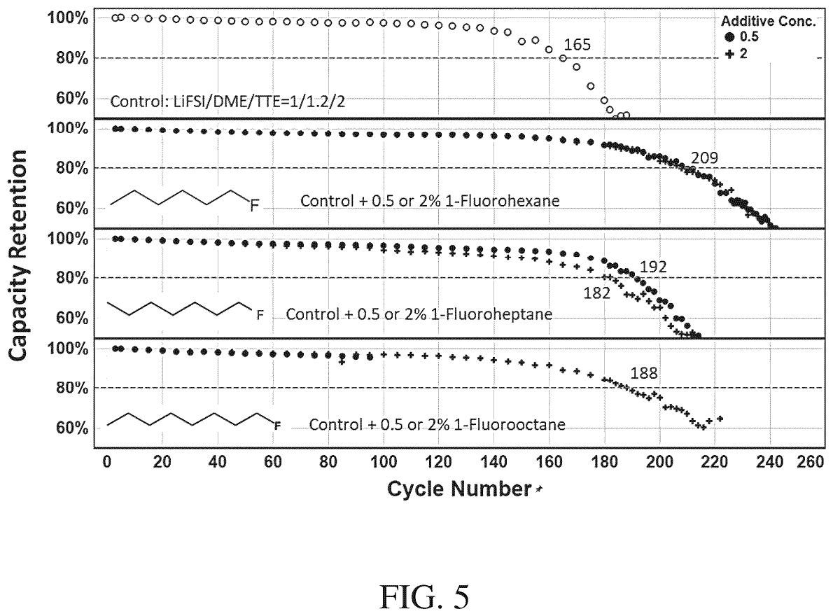

The effect of differing monosubstituted halogenated linear alkane additives (1-fluorohexane, 1-fluoroheptane and 1-fluorooctane) on cycling performance of lithium metal batteries is shown in FIG. 5. Each of these additives improved the cycling performance substantially with the monosubstituted fluorinated shorter chain additive exhibiting the greatest cycle life, which is consistent with the results for the linear disubstituted chlorinated alkane additives. These monosubstituted halogenated alkanes also exhibit less concentration effect compared to the disubstituted halogenated alkanes.

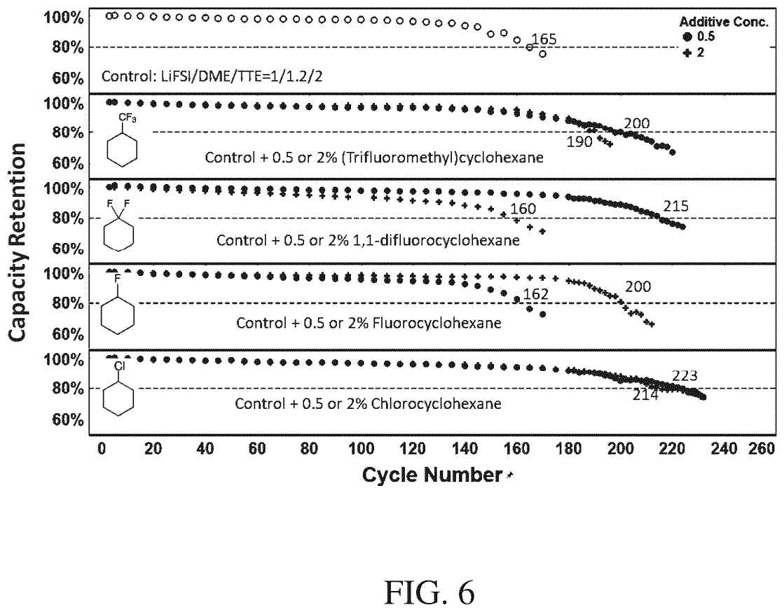

The use of cyclic halogenated alkanes as an additive in the electrolyte of LMB cycling behavior is shown in FIG. 6. FIG. 6 shows that the cyclic halogenated alkane additives when added to the electrolyte improve the cycling life of LMBs to a similar extent as the linear halogenated alkanes.

TABLE 1

| | | | | Cycle Life |
|---|---|---|---|---|
| | Cy1 Cap | Cy1 CE | Cy3 Cap | (@80% |
| Additive | (mAh/g) | (%) | (mAh/g) | Cap Ret) |
| NA (Control) | 196.8 | 89 | 193.5 | 165 |
| +0.5% 1,2- | 191.2 | 88 | 195.3 | 197 |
| dichloroethane | | | | |
| +2% 1,2- | 194.1 | 88 | 192.4 | 204 |
| dichloroethane | | | | |
| +0.5% 1,3- | 203.6 | 89 | 192.8 | 217 |
| dichloropropane | | | | |
| +2% 1,3- | 203.3 | 89 | 193.9 | 185 |
| dichloropropane | | | | |
| +0.5% 1,4- | 202.6 | 89 | 193.0 | 85 |
| dichlorobutane | | | | |
| +2% 1,4- | 202.8 | 87 | 192.5 | 23 |
| dichlorobutane | | | | |
| +0.5% 1,6- | 194.2 | 87 | 190.1 | 75 |
| dichlorohexane | | | | |
| +2% 1,6- | 197.0 | 86 | 183.2 | 4 |
| dichlorohexane | | | | |

What is claimed is:

1. An electrolyte comprising a solution comprised of a solvating solvent, lithium salt and a halogenated alkane in an amount of 0.05% to 5% by weight of the electrolyte.

2. The electrolyte of claim 1, wherein the amount is 0.1% to 2%.

3. The electrolyte of claim 1, wherein the halogenated alkane has from 1 to 12 carbons.

4. The electrolyte of claim 1, wherein the halogenated alkane is substituted with at most 5 halogens.

5. The electrolyte of claim 4, wherein the halogenated alkane is substituted with at most 3 halogens.

6. The electrolyte of claim 1, wherein the halogenated alkane is cyclic.

7. The electrolyte of claim 1, wherein the halogenated alkane is linear.

8. The electrolyte of claim 7, wherein the halogenated alkane is monosubstituted.

9. The electrolyte of claim 8, wherein the halogenated alkane has from 1 to 10 carbons.

10. The electrolyte of claim 7, wherein the halogenated alkane is at least di-substituted with a halogen.

11. The electrolyte of claim 10, wherein the halogens present in the halogenated alkane are not separated by more than 1 carbon.

12. The electrolyte of claim 11, wherein the halogenated alkane has from 1 to 10 carbons.

13. The electrolyte of claim 1, wherein the halogenated alkane is substituted with chlorine, fluorine or combination thereof.

14. The electrolyte of claim 1, wherein the halogenated alkane is substituted with either chlorine or fluorine, but not both.

15. The electrolyte of claim 1, wherein the electrolyte is a localized high salt concentration electrolyte (LHCE) further comprised of a diluent.

16. The electrolyte of claim 15, wherein the LHCE is comprised of a lithium bis (fluorosulfonyl) imide (LiFSI), dimethoxyethane (DME), 1,1,2,2-tetrafluoroethyl 2,2,3,3-tetrafluoropropyl ether (TTE) combination; LiFSI, DME, 1,2-(1,1,2,2-Tetrafluoroethoxy) ethane (TFEE) combination; LiFSI, DME, 1H,1H,5H-octafluoropentyl 1,1,2,2,-tetrafluoroethyl ether (OFPTFEE) combination; LiFSI, DME, 1,3-(1,1,2,2-Tetrafluoroethoxy) propane (TFEP) combination; LiFSI, DEE, TTE combination; LiFSI, DEE, TFEE combination; LiFSI, DEE, OFPTFEE combination; or LiFSI, DEE, TFEP combination.

17. A battery comprised of the electrolyte of claim 1, a cathode, anode and separator.

18. The battery of claim 17, wherein the anode is comprised of a lithium metal anode.

19. The battery of claim 17, wherein the cathode is a layered oxide.

20, The battery of claim 19, wherein the layered oxide is comprised of Ni, Mn, Co and the Ni is at least 50% by mole of the Ni, Mn and Co in the layered oxide.
